(19) United States
(12) Patent Application Publication
(10) Pub. No.: US 2026/0013488 A1
(43) Pub. Date: Jan. 15, 2026

(54) REEL COVER

(71) Applicant: Jeanne Sutton, Prairieville, LA (US)

(72) Inventor: Jeanne Sutton, Prairieville, LA (US)

(21) Appl. No.: 19/267,501

(22) Filed: Jul. 12, 2025

Related U.S. Application Data
(60) Provisional application No. 63/671,746, filed on Jul. 15, 2024.

(51) Int. Cl. A01K 97/00; A01K 89/00

(52) U.S. Cl. CPC A01K 97/00; A01K 89/00

(57) ABSTRACT

An improved apparatus for protecting a fishing reel in the form of an adjustable cover with multiple apertures and straps designed to accommodate various reel shapes and types without having to alter the reel into an unusable state by removing handles, line, or other components.

### BACKGROUND OF THE INVENTION

In the field of fishing, there are few components that are more important to the angler than the fishing reel. Since this part of the fishing rig is responsible for the extendable element that is used for casting to the intended prey, it is essential for the effectiveness and feel of the cast, capture and effectiveness of the fishing exercise. In order to enhance those aspects of fishing, the humble reel has become increasingly sophisticated and expensive.

Fishing reels have long been known in the art as an essential component, and as such, they have developed dramatically more features and increases in efficiency as well as complexity over the years. As a result, additional and more precise components have become increasingly common, and the cost for those reels as a result of the uptick in complexity has increased exponentially. As with anything, with an increase in sophistication, one can expect a commensurate increase in cost.

Consequently, the fishing reel now represents a significant investment by an angler in his fishing equipment, and therefore a need to protect the reel has also become a very real concern. Unfortunately, due to the design of most reels, this is easier said than done, due to the inherent design of modern reels, which are replete with extruding parts, expanding sizes and more. As the components of the reel increase in number and complication, this becomes more of a challenge, particularly if the reel is often used and left loaded and/or rigged with fishing line and ready to fish, which adds another item extending from the reel, namely the fishing line itself.

Further illustrating these extended items, fishing reels can comprise not only the reel body and reel spool itself, but also a reel handle, bail, line and more, which more often than not, protrude out from the reel, making containment difficult within a case of the traditional design. Add to this the line itself which extends from the reel spool down the fishing rod through each eyelet, and one can readily ascertain the difficulties in protecting all these components whole allowing easy access to same, as the awkward and irregular dimensions do not lend themselves to encasement.

Further still, a fishing rod and reel is generally a lengthy item, making stowage and transport challenging because it cannot simply be tossed into a duffle bag or backpack, and it is often stored in or on an automotive backseat, truck bed or other area that can accommodate such an item. These spaces lend themselves to damage as a result, making the need for protecting the reel even more acute.

Some cases have been attempted in the current state of the art; however, these have been simple efforts to contain a reel that may only accommodate a reel with a foldable or no handle, zero or minimal protrusions, and/or are otherwise cumbersome to operate over a fishing reel.

The present invention addresses all of these concerns with an effective fishing reel cover which is able to effectively, quickly and easily accommodate a multitude of most fishing reel configurations and sizes without having to un-rig the pole and reel. This saves time by avoiding having to rig and un-rig a reel each time it is uncovered/covered, as well as the loss of line as a consequence of same, and the wear and tear on each component required to be employed to rig and un-rig the fishing reel and rod.

### SUMMARY OF THE INVENTION

An improved apparatus for protecting a fishing reel in the form of an adjustable cover with multiple apertures and straps designed to accommodate various reel shapes and types without having to alter the reel into an unusable state by removing handles, line, or other components. In addition to the novel designs presented herein, there are several novel features which this invention advances, described in the detailed description below.

### OBJECTS OF THE INVENTION

One object of this invention is to provide a reel cover that is able to protect a fishing reel.

An additional object of this invention is to provide a reel cover that is able to accommodate a reel with a handle extending therefrom.

Another object of this invention is to provide a reel cover that is able to accommodate a fishing reel without having to remove or reel in the line fully from the rod to the reel.

A further object of this invention is to provide a reel cover with securing straps which form and secure an aperture for fitment around a fishing line while rigged up on a fishing pole/reel.

Yet another object of this invention is to provide a reel cover that is able to easily be put onto a fishing reel.

Still another object of this invention is to provide a reel cover that can easily be fastened around a reel with accommodations for right- and left-handed configured reels and/or bails.

Still another object of this invention is to provide a durable reel cover.

Still another object of this invention is to provide a reel cover that is able to have adjustable opening sizes with adjustable straps.

Still another object of this invention is to provide a reel cover that is able to drain and is breathable to prevent the collection of water and resultant damage from same.

Still another object of this invention is to provide a reel cover that is able to accommodate a reel with a bail extending therefrom.

### BRIEF DESCRIPTION OF DRAWINGS

FIG. 1 is a front view of the reel cover.

FIG. 2 is a perspective view of the reel cover.

FIG. 3 is a perspective front view of the reel cover with a rod and reel inside.

FIG. 4 is a perspective rear view of the reel cover with a rod and reel inside.

FIG. 5 is a perspective rear view of the reel cover with a rod and reel inside.

FIG. 6 is a perspective front view of the reel cover with a left-hand rod and reel inside with a loaded fishing line.

FIG. 7 is a perspective front view of the reel cover with a right-hand rod and reel inside with a loaded fishing line.

FIG. 8 is a top view of the reel cover.

FIG. 9 is a bottom view of the reel cover.

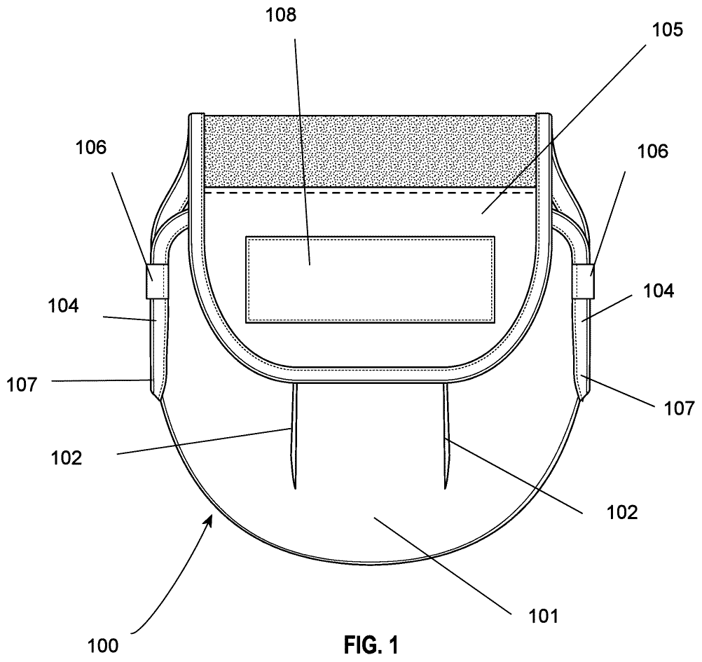

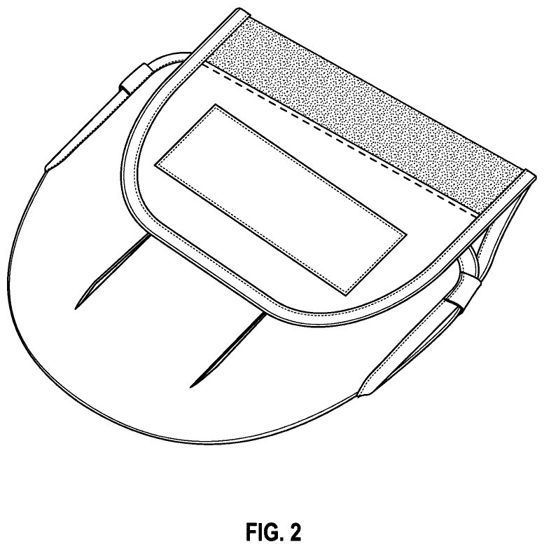

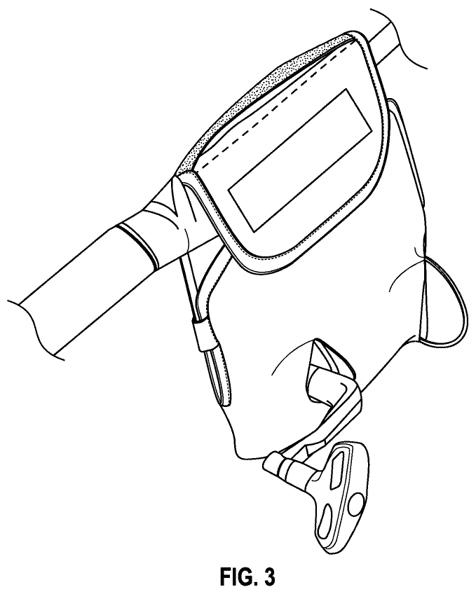

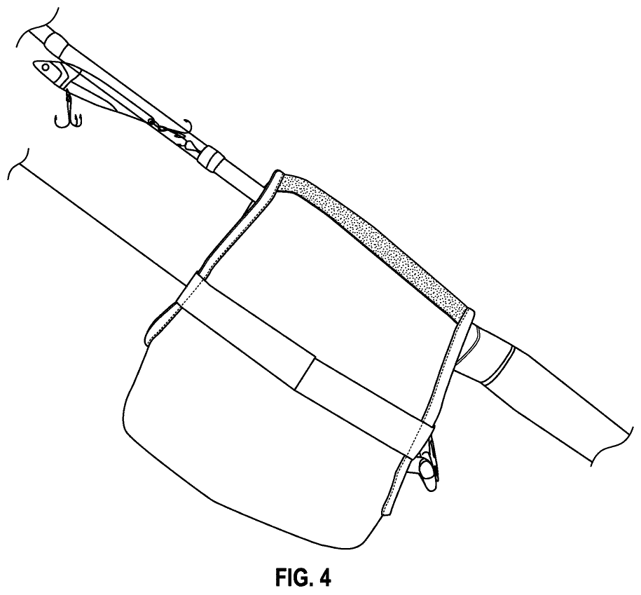

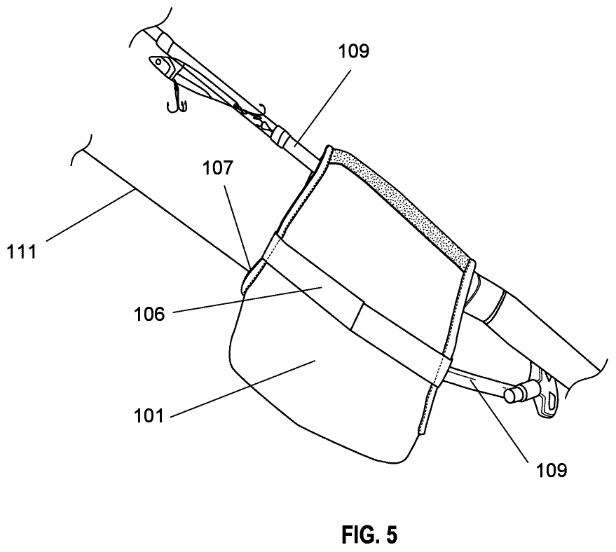

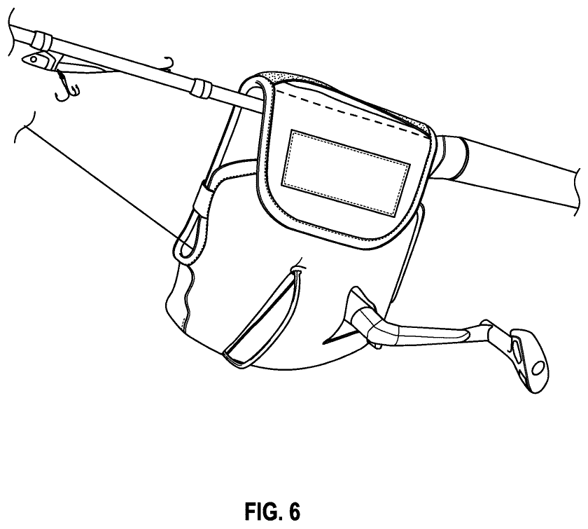

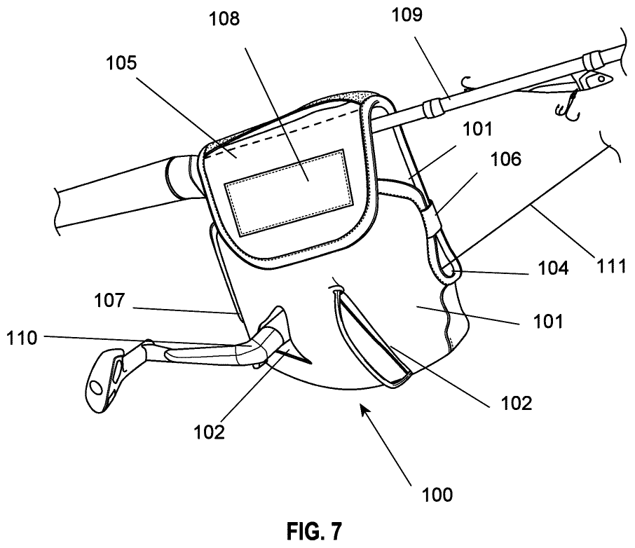

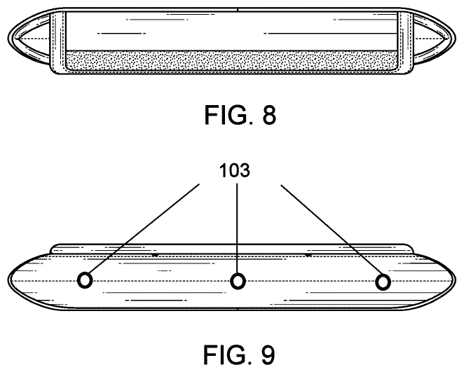

### DETAILED DESCRIPTION OF THE INVENTION

This application presents novel designs of a reel cover 100, as shown in the FIGs. In addition, there are novel utilitarian and design feature sets which this invention advances.

Reel cover 100 as disclosed herein is comprised of flexible and durable fabric shell 101 that is pre-cut, notched, assembled and folded in a particular way so as to accommodate a multitude of reels 110 and reel configurations.

Reel cover's 100 fabric shell 101 material is thus designed and shaped and ultimately folded to substantially wrap around the body of reel 110 in a pouch-shaped configuration, and then further configured to wrap around the top of attached rod 109, with overlapping section 105 and/or attaching section back again over itself, thus “closing” reel cover 100 around the rig, enclosing reel 110, top of rod 109, and portions of the extending component parts of reel 110 like the reel handle and bail inside of the pouch or body of reel cover 100. Cutouts in the form of slits or apertures 102, which may be reinforced, may also be provided on one or both sides of reel cover 100 to allow a handle, bail, or other extending components of reel 110 and/or rod 109 to protrude out of reel cover 100 while substantially protecting the rest of reel 110. Fishing line apertures 104 can also be provided that allow a rigged line to extend outward and not interfere with the covering and securing of rod 109 and or reel 110.

The pouch, or body, of reel cover 100 is therefore a pocket-shaped enclosure that is sized to accommodate fishing reel 110, and can be provided in multiple sizes to accommodate differing reel sizes. The pouch can contain slits, openings, or apertures 102 as defined elsewhere in this disclosure, in order to allow for various features to be employed. This body is the main structural portion of the invention.

The pouch, or body of reel cover 100 where reel 110 itself is inserted into, can, and in the exemplary embodiment does, further employ a section of fabric at the opening of the body that overlaps itself, such that the entirety of reel cover 100 is closed around reel 110, creating a substantially enclosed covering enclosing reel 110 and a portion of rod 109. This overlapping section 105 of fabric can also utilize fasteners of various types to effectuate the secure closing of reel cover 100 to more fully secure the body of reel cover 100 around reel 110 and/or rod 109.

This overlapping section 105 can be as simple as the wrapping of fabric shell 101 over itself, which could be inserted into the opposing section of the body, or can also employ other securing means, such as hook-and-loop material as in the FIGs., which ensures reel cover 100 remains “closed” around reel 110 by securing one end of reel cover 100 to the other, encapsulating reel 110. Hook-and-loop material can also be replaced or complemented with other types securing means, including plastic or metal snaps, clips, magnets, or other securing means.

Fabric shell 101 of reel cover 100 used can be any number of materials that are ideally water-resilient and simultaneously durable and soft so as not to damage reel 110 and/or other components it seeks to protect. In the exemplary embodiment presented, reel cover 100 is comprised of neoprene, or similar material, thus providing the desired material which is durable on the exterior, yet non-abrasive on the interior.

Fabric shell 101 is further ideally enhanced with technology that makes it snag-resistant, by incorporating a material such as neoprene. Given the application of this invention, hooks and other snag-prone items are in common use. This type of snag-resistant material is thus ideally suited to prevent such items which are used in the direct proximity of reel cover 100 from getting caught on and in the reel cover's 100 fabric shell 101, helping to preclude damage to reel cover 100 as well as the snagging implements themselves.

Some items in the prior art may include designs which can accommodate a handle using a rudimentary means with the same goal of the present invention. However, no design known affords a fishing line slot as designed herein either alone or in conjunction with reel cover 100. Further, this design feature is employed to accommodate a fishing line on a rigged pole which can be incorporated on the left, right or both sides of reel cover 100 so that either left- or right-handed reel/pole configurations can be accommodated.

An ambidextrous design is accomplished by the use of a dual aperture 102 design in the body of reel cover 100 as well as a dual securing strap closure 106 and dual V-shaped channels 104 as part of the body of reel cover 100. By having two slots, two straps, and two V-shaped channels 107, reel cover 100 can be placed over reel 110 having a left- or right-handed reel configuration in the same manner and without having to have two different configurations of reel cover 100. Additionally, the reel handle and/or bail can extend out of either of two apertures 102 depending on how the user chooses to wrap reel cover 100 around reel 110 and rod 109.

In either use case, the design presented utilizes V-shaped channels 107 on at least two, generally opposing sides, of the pouch of reel cover 100, and specifically at the top of the pouch of reel cover 100, as shown in the FIGs. This creates openings that allow a rigged fishing pole's length (with or without bait, lures, hooks, etc.) to exit reel 110 as it typically would without interference from reel cover 100. As such, no removal of line, bait, or rigging is required to protect and secure reel 110.

V-shaped channels 107 can be coupled with a fastening strap system, or closures 106 that include at least one closure 106 that extends from one side of V-shaped channels 102 formed in the reel cover 100 to the other by wrapping around and attaching to either the reel cover 100 or another strap. This further defines V-shaped channel 107 on the base, and the strap forming the top of a substantially enclosed V-shaped channel 102 which can be used to secure the reel cover 100 around fishing line and/or rod 109.

Closures 106 can be attached to one another, or from strap to reel cover 100 using securing means such as hook-and-loop material as in the FIGs., which ensures closures 106 remain “closed” around line and/or rod 109. Hook-and-loop material can also be replaced or supplemented with any number of closure types, including plastic or metal snaps, clips, magnets, or other securing means.

Closures 106 also have the added benefit of providing an additional securing means for reel cover 100 to the rigged fishing pole, in that closures 106, when closed, wrap around the line, helping secure the cover onto rod 109, not allowing reel cover 100 to fall off.

Also included in fishing reel cover 100 is a labelling system which incorporates ID plate 108, or fastener panel to which a corresponding fastener placard may be attached bearing an identifying feature, such as a panel that can be written on, or inscribed panels, can be detachably affixed thereto. In this way, reel cover 100, and when installed, rigged reels 110, can be quickly identified. This may be a hook-and-loop system as shown in the FIGs, or can also be any number of attachment types, including plastic or metal snaps, clips, magnets, or other securing means. ID Plate 108 can be used to display branding, or identification of reel 110 contained therein. This can be done with direct printing, a hook and loop badge attachment system or other identification plate types.

Drain apertures 103 in the bottom of reel cover 100 are also included to allow for additional ventilation and draining through fabric shell 101 for reels 110 contained therein. Since often reels 110 may be wet when stored, this allows them to drain in any orientation, whether through the top, bottom, or sides, as well as allowing for cross-ventilation which is conducive for drying and prevention of moisture buildup.

Another design feature incorporated into reel cover 100 is the use of reinforced edges along fabric shell 101 at points which are likely to encounter increased wear or separation. This is useful both to extend the life of reel cover 100, but also helps insulate rod 109, reel 110 and rigging against wear, as the reinforced edges have the added benefit of being more padded as a result of the reinforcement creating an inherent padding.

It should be noted that another feature is extensibility in sizing of reel cover 100. Since the features scale up or down due to the manner in which they are employed, a direct scaling up or down can accommodate larger or smaller reels 110. This would not necessarily be accomplished in a different design, but the mirror-imaged slots and hook-and-loop fasteners can be scaled up or down in almost exact proportions which result in a corresponding change in the ability to accommodate reels 110 scaling up and down in the same proportion.

1. A reel cover comprising a foldable fabric shell, wherein:
a. said fabric shell is folded to form a pouch shaped to receive a fishing reel;
b. said folded fabric shell comprises an overlapping section of said fabric shell;
c. further wherein a plurality of sections of said folded fabric shell forms a pair of opposing V-shaped channels, shaped to wrap substantially around a fishing rod;
d. said reel cover further comprising at least one fishing line aperture in said fabric shell configured to permit a fishing line to pass unobstructed from within said pouch to the exterior of said pouch;
e. said reel cover further comprising at least one closure configured to define the size of said V-shaped channels and said pouch; and
f. said reel cover further comprising at least one pair of apertures on the same side of said reel cover shaped to permit the passage of at least one items from the group of fishing reel handle or bail from within said pouch to the exterior of said pouch.

2. The reel cover of claim 1 further comprising a plurality of drains in a bottom section of said pouch of said reel cover.

3. The reel cover of claim 1 further comprising an ID plate affixed to said overlapping section of said fabric shell.

4. The reel cover of claim 2 further comprising an ID plate affixed to said overlapping section of said fabric shell.
